(19) United States
(12) Patent Application Publication
(10) Pub. No.: US 2017/0346207 A1
(43) Pub. Date: Nov. 30, 2017

(54) BASE STRIP FOR CONNECTION TO A PRINTED CIRCUIT BOARD

(71) Applicant: Phoenix Contact GmbH & Co. KG, Blomberg (DE)

(72) Inventor: Senta Pietschmann, Detmold (DE)

(21) Appl. No.: 15/528,766

(22) PCT Filed: Nov. 2, 2015
(86) PCT No.: PCT/EP2015/075413

§ 371 Date: May 23, 2017

(30) Foreign Application Priority Data
Nov. 25, 2014 (DE) 10 2014 117 233.7

(51) Int. Cl. H01R 12/71; H01R 13/50; H01R 12/50

(52) U.S. Cl. CPC H01R 12/716; H01R 23/72; H01R 13/50; H01R 23/6806; H01R 23/70

(57) ABSTRACT

A base strip for connection to a printed circuit board includes a first side wall that extends lengthwise along a longitudinal direction; a second side wall that extends lengthwise along the longitudinal direction and that is at a distance from the first side wall along a crosswise direction that is oriented crosswise to the longitudinal direction, so that, between the side walls, a receiving space is formed into which one or more plug-in elements can be inserted in the insertion direction; and a base that connects the first side wall and the second side wall to each other and that has a plurality of receiving openings to-receive electric contact elements. The center of gravity of the base strip corresponds to the geometric center of gravity of an imaginary cuboid that envelops the base strip.

### CROSS-REFERENCE TO PRIOR APPLICATIONS

This application is a U.S. National Phase application under 35 U.S.C. §371 of International Application No. PCT/EP2015/075413, filed on Nov. 2, 2015, and claims benefit to German Patent Application No. DE 10 2014 117 233.7, filed on Nov. 25, 2014. The International Application was published in German on Jun. 2, 2016 as WO 2016/083079 A1 under PCT Article 21(2).

### FIELD

The invention relates to a base strip for connection to a printed circuit board.

### BACKGROUND

Such a base strip serves to electrically connect one or more plug-in elements to a printed circuit board. For this purpose, the base strip can be placed onto a printed circuit board and then electrically connected to it via appropriate contact elements. By means of the base strip, one or more plug-in elements can be inserted and engaged so as to connect the plug-in elements to the printed circuit board in this manner.

Such a base strip has a first side wall that extends lengthwise along a longitudinal direction and a second side wall that extends lengthwise along the longitudinal direction. The side walls are at a distance from each other along a crosswise direction that is oriented crosswise to the longitudinal direction, so that, between the side walls, a receiving space is formed into which one or more plug-in elements can be inserted in the insertion direction, so that the plug-in elements are accommodated in the receiving space when they are in the inserted position. The side walls are connected to each other via a base that extends crosswise between the side walls, whereby a plurality of receiving openings to receive electric contact elements, for instance, contact pins, is provided on the base.

Such a base strip is usually produced in one piece out of plastic. In this context, the production takes place in a suitable plastic mold at an elevated temperature. The workpiece cools off after it has been removed from the mold, a process that can be accompanied by shrinkage of the material of the workpiece. If differing degrees of material shrinkage occur in different sections of the workpiece, this can cause warping and deformation of the base strip produced in this manner.

Due to shrinkage effects, the shape of a finished base strip can thus diverge from the actually desired shape. In particular, a curvature can appear in individual sections of the base strip or else the base strip can be bent in its entirety.

Nowadays, such base strips are employed especially within the scope of the automated assembly of printed circuit boards. In this context, in an automated step, an automatic assembly unit picks up a base strip and places it together with other components onto a printed circuit board, whereby the components placed onto the printed circuit board are then soldered together with the printed circuit board in a so-called reflow soldering process. The most commonly used process is so-called through-hole-reflow soldering (“THR” soldering for short), in which the plug-in contacts are inserted into openings on the printed circuit board. However, if shrinkage effects have caused the base strip to deviate excessively from the actual target shape, flaws can occur when the contact elements of the base strip are soldered, thus giving rise to soldered connections that might be flawed.

This should be avoided.

Such shrinkage effects that can change the shape of a base strip are magnified in the case of multi-pin base strips, in other words, relatively large base strips with a plurality of contact elements, for instance, more than twelve contacts.

A wide array of designs of base strips is known from the state of the art and described, for example, in European patent application EP 1 672 744 A2, German utility model DE 20 2006 018 590 U1, European patent application EP 0 748 005 A1 and U.S. Pat. No. 6,645,005.

### SUMMARY

In an embodiment, the present invention provides a base strip for connection to a printed circuit board, comprising: a first side wall that extends lengthwise along a longitudinal direction; a second side wall that extends lengthwise along the longitudinal direction and that is at a distance from the first side wall along a crosswise direction that is oriented crosswise to the longitudinal direction, so that, between the side walls, a receiving space is formed into which one or more plug-in elements can be inserted in the insertion direction; and a base that connects the first side wall and the second side wall to each other and that has a plurality of receiving openings configured to receive electric contact elements, wherein the center of gravity of the base strip corresponds to the geometric center of gravity of an imaginary cuboid that envelops the base strip.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1A a side view of a base strip;

FIG. 1B a bottom view of the base strip;

FIG. 1C a top view of the base strip;

FIG. 2A a cross-sectional view along line A-A according to FIG. 1A;

FIG. 2B a cross-sectional view along line B-B according to FIG. 1A;

FIG. 3 a partial bottom view of the base strip;

FIG. 4 a partial top view of the base strip;

FIG. 5 a side view of the base strip with an enveloping cuboid;

FIG. 6 the cross-sectional view according to FIG. 2A, together with the enveloping cuboid;

FIG. 7A the cross-sectional view according to FIG. 2B, with a contact element inserted into a receiving opening;

FIG. 7B the cross-sectional view according to FIG. 2B, with another contact element inserted into the receiving opening;

FIG. 8A a schematic view of the base strip depicting deformation in the plane spanned by the insertion direction E and the longitudinal direction L; and

FIG. 8B a schematic view of the base strip depicting in the plane spanned by the crosswise direction Q and the longitudinal direction L.

### DETAILED DESCRIPTION

Accordingly, the center of gravity of the base strip corresponds to the geometric center of gravity of an imaginary cuboid that envelops the base strip.

In this context, the term “enveloping cuboid” refers to the smallest (imaginary) cuboid that completely surrounds the base strip. Therefore, the enveloping cuboid corresponds to a cuboid that touches the base strip at its outer walls and envelops the base strip, analogously to the mathematical definition of an envelope.

The cuboid is a geometric body according to the familiar definition thereof, having six rectangular surfaces whose angles are all right angles.

There is precisely one enveloping, imaginary cuboid, in other words, a geometric cuboid with a minimum volume, that completely surrounds the base strip. Thus, the imaginary, enveloping cuboid is defined exactly mathematically.

The term “base strip” in this context refers to a (plastic) molded part onto which no contact elements have yet been placed.

The base strip is preferably made in one piece out of plastic. Contact elements can be placed onto the base strip at the appertaining receiving openings. An electric connection to a printed circuit board can be established via such contact elements.

The invention is based on the surprising, empirically ascertained realization that the deformation of the base strip caused by material shrinkage can be reduced through a suitable selection of the position of the center of gravity of the base strip. Since the center of gravity of the base strip corresponds at least approximately to the center of gravity of the enveloping cuboid (precise to within 10%, preferably precise to within 1%, relative to the total dimensions, e.g. the total length, of the base strip), the result is an advantageous material distribution in the base strip. The geometric center of gravity of the enveloping cuboid is at the geometric midpoint of the cuboid. This is also where the center of gravity of the base strip is, so that the material of the base strip is distributed uniformly around its geometric midpoint.

Since a uniform shrinkage can occur around the center of gravity, a base strip undergoes less deformation while it is being produced and especially while it is cooling off after being produced, so that the base strip can be produced so as to correspond precisely to its desired shape.

This especially translates into a safe and reliable placement of the base strip onto a printed circuit board, resulting in the reliable production of soldered connections to the contact elements placed onto the base strip.

The insertion direction is preferably oriented perpendicular to the longitudinal direction and perpendicular to the crosswise direction. Consequently, the side walls extend flat in parallel planes that are spanned by the insertion direction and the longitudinal direction, and are at a distance from each other crosswise, that is to say, along the crosswise direction. The base, in contrast, is spanned by the crosswise direction and the longitudinal direction, and it extends crosswise between the side walls. Therefore, the base strip has a U-shaped basic form into which the one or more plug-in elements can be inserted from above in the insertion direction.

In the receiving space of the base strip, preferably several plug-in sites are defined that are separated from each other by guide webs which are at a distance from each other along the longitudinal direction, which protrude into the receiving space and which extend along the insertion direction. Between two guide webs, for example, a plug-in site for a (single-pin) plug-in element is defined, whereby it is fundamentally possible to arrange a multi-pin plug-in element at several plug-in sites of the base strips.

The guide webs on the inside of the first side wall extend along the insertion direction on the first side wall and they protrude into the receiving space. Here, however, the guide webs advantageously do not extend over the entire height of the receiving space, but rather, for instance, an end edge of the first side wall projects towards the outside beyond the guide webs.

The guide webs that extend along the insertion direction and that define the plug-in sites also contribute to the reinforcement of the base strip. The stiffness of the base strip can also be enhanced in that a side surface of the first side wall extends flat along the longitudinal direction and is thus formed as a flat surface. This yields a shape that is easy to produce and that can require less material than conventional base strips do.

The base that extends crosswise between the side walls is preferably likewise configured so as to be flat on a bottom that faces the receiving space. Projecting from this bottom, there can be domes which project into the receiving space and on which receiving openings are arranged through which electric contact elements can be inserted. After the base strip has been produced, contact elements can be inserted, for example, into the receiving openings, and can be pressed so as to be crimped with the receiving openings, as a result of which the contact elements are firmly connected to the base strip after completion.

In an advantageous embodiment, on the outside facing away from the receiving space, the base has a plurality of crosswise webs that run along the crosswise direction on the outside of the base and that can extend crosswise, for example, over the entire width of the base. In each case, two crosswise webs in pairs can accommodate a receiving opening between them so that a contact element comes to rest between the crosswise webs when said contact element is inserted into an associated receiving opening of the base strip.

Fundamentally, the base strip can be brought into contact with various contact elements. For instance, contact elements in the form of pins can be used that are placed onto the base strip along the insertion direction and that project beyond the base on the outside thereof along the insertion direction. By the same token, it is also conceivable to employ angled contact elements in the form of L-shaped pins that are angled in the area of the outside of the base and that extend with an angled section between the crosswise webs. Such an angled pin is thus guided with its angled section between the crosswise webs.

Owing to the use of such different contact elements, the base strip can be placed onto a printed circuit board in various orientations. For example, the base strip can be placed onto an associated printed circuit board in a position in which the base faces the printed circuit board. Alternatively, the base strip can be placed onto an associated printed circuit board in a position in which one of the side walls comes to rest against the printed circuit board.

The crosswise webs preferably have a symmetrical design (relative to a plane of symmetry that is spanned by the longitudinal direction and the insertion direction and that runs through the center of gravity). The crosswise webs also contribute to the reinforcement of the base strip.

In an advantageous embodiment, the base strip is made of a liquid crystal polymer (LCP for short). Such a liquid crystal polymer contains so-called mesogens that form molecule chains in the polymer. LCP exhibits a high tensile strength, especially along its molecule axes, and a high modulus of elasticity, as a result of which materials displaying outstanding strength characteristics can be made.

A base strip of the type described here is configured especially as a multi-pin base strip, in other words, as a base strip for use with a plurality of contact elements, for instance, more than twelve contact elements. For example, such a base strip can have twelve, twenty-four or forty-eight receiving openings for the placement of contact elements. Fundamentally, however, a base strip of the type described here can also be used as a base strip having few pins, for example, less than twelve receiving openings for contact elements.

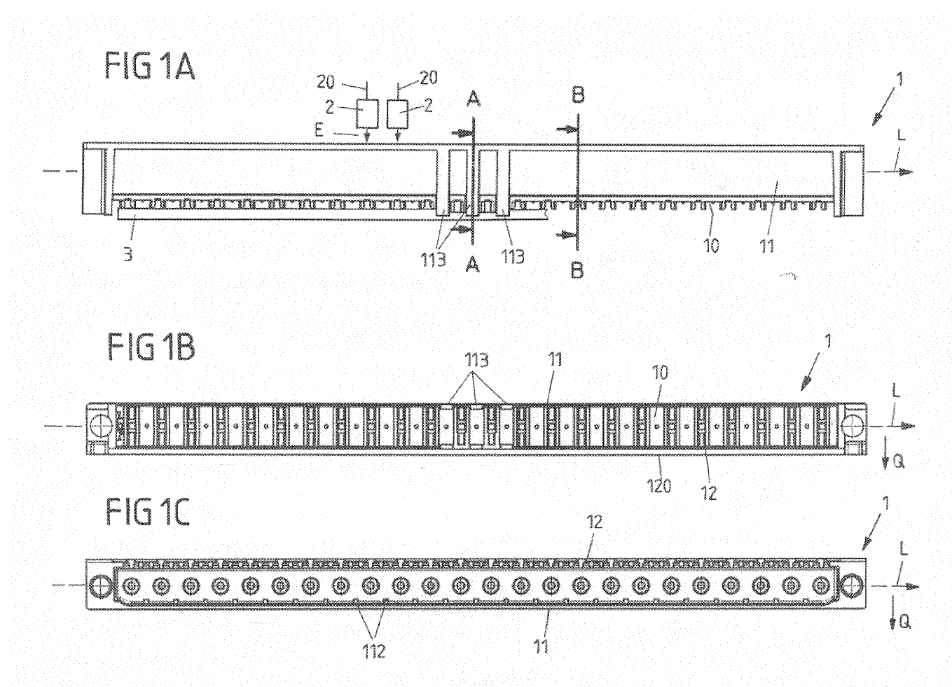

FIGS. 1A-1C to FIG. 4 show an embodiment of a base strip 1 that is made in one piece out of plastic, for instance, LCP, and that can be placed onto a printed circuit board 3 in order to allow the lines 20 associated with plug-in elements 2 to be electrically connected to the printed circuit board 3.

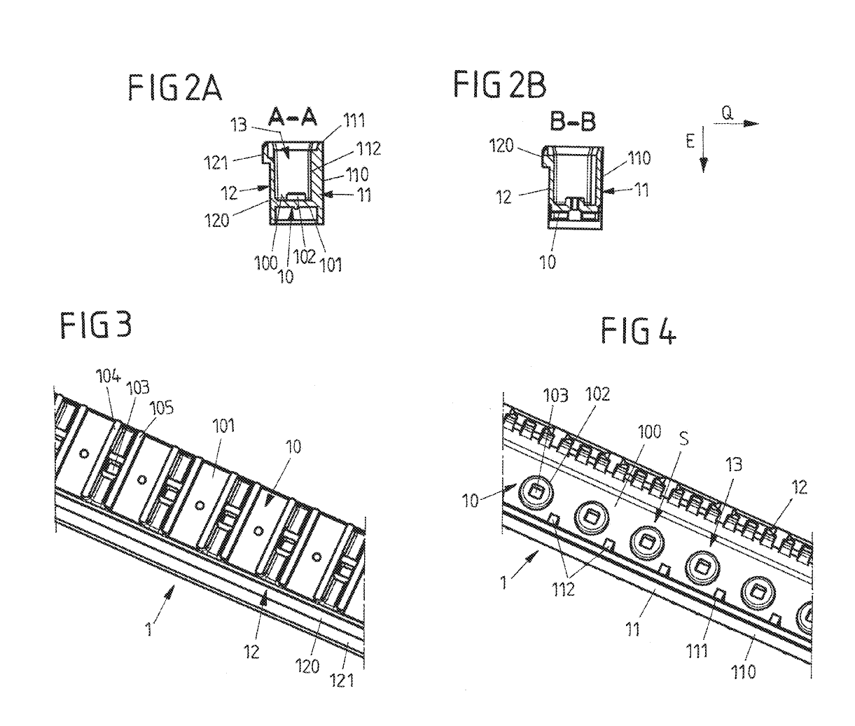

The profile of the base strip 1 formed in one piece out of plastic (see the sectional views according to FIGS. 2A and 2B) is essentially a U-shaped basic form having a base 10 and side walls 11, 12. The side walls 11, 12 extend here in parallel planes and are at a distance from each other along the crosswise direction Q. The base 10 connects the side walls 11, 12 to each other and, in order to do so, it extends crosswise between the side walls 11, 12.

The base strip 1 extends lengthwise along a longitudinal direction L. Plug-in elements 2 can be inserted perpendicularly in an insertion direction E into a receiving space 13 formed between the side walls 11, 12, whereby a plurality of plug-in sites S where the plug-in elements 2 can be inserted are defined on the base strip 1 inside the receiving space 13.

The side walls 11, 12 extend in parallel planes that are each spanned by the insertion direction E and the longitudinal direction L. In contrast, the base 10 extends in a plane that is spanned by the crosswise direction Q and the longitudinal direction L.

The side walls 11, 12 differ from each other.

Thus, a side surface 110 of the side wall 11 extends essentially flat along the longitudinal direction L, whereby on the inside of this side surface 110, there are guide webs 112 that extend along the insertion direction E and that protrude into the receiving space 13 between the side walls 11, 12.

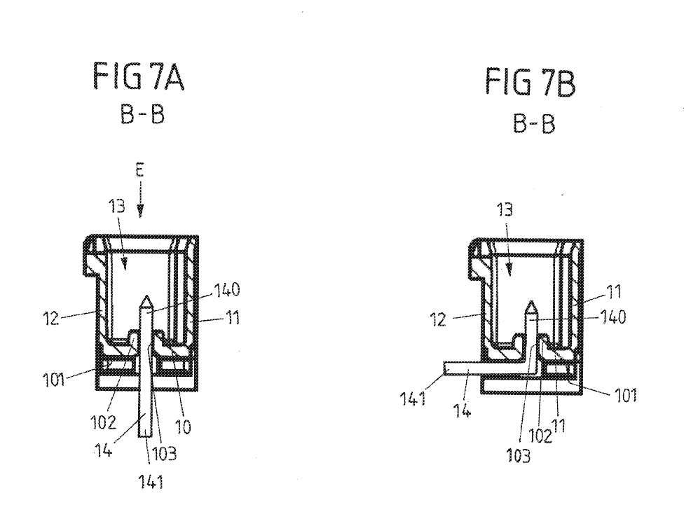

The guide webs 112 serve to define the plug-in site S inside the receiving space 13. For this purpose, the guide webs 112 are arranged regularly on the side wall 11 at a distance from each other, whereby a receiving opening 103 on a projecting dome 102 on the bottom 100 of the base 10 is associated with each plug-in site S between two guide webs 112. A contact element 14 (see FIGS. 7A and 7B) can be inserted in such a way that it projects inwards into the receiving space 13 and therefore can be electrically contacted with a plug-in element 2.

Since the guide webs 112 extend lengthwise along the insertion direction E, a plug-in element 2 can be placed between two guide webs 112 and then pushed into the receiving space 13. The guide webs 112 constitute a code that ensures that a plug-in element 2 can only be placed onto a desired plug-in site S in the correct orientation.

Starting from the bottom 100 of the base 10, the guide webs 112 extend almost over the entire height of the side surface 110 of the side wall 11, whereby an end edge 111 of the side wall 11 projects (slightly) beyond the guide webs 112.

On the opposite, second side wall 12, there is an end strip 121 that is located on an edge extending from the bottom 100 of the base 10 and that protrudes outward beyond a flat side surface 120 of the second side wall 12. In a generally known manner, plug-in sites for the encoding elements can be arranged on this end strip 121 and they permit an encoding of the base strip in such a way that only specific plug-in elements 2 (namely, only those that, for instance, are encoded with a corresponding counter-encoding) can be placed onto the base strip 1.

On the outside of the base 10 facing away from the receiving space 13, there are crosswise webs 104, 105 that extend crosswise over the entire width of the base 10 as seen in the crosswise direction Q. In each case, two crosswise webs 104, 105 enclose a receiving opening 103 between them so that a contact element 14 comes to rest between two crosswise webs 104, 105 once a contact element 14 has been inserted into a receiving opening 103.

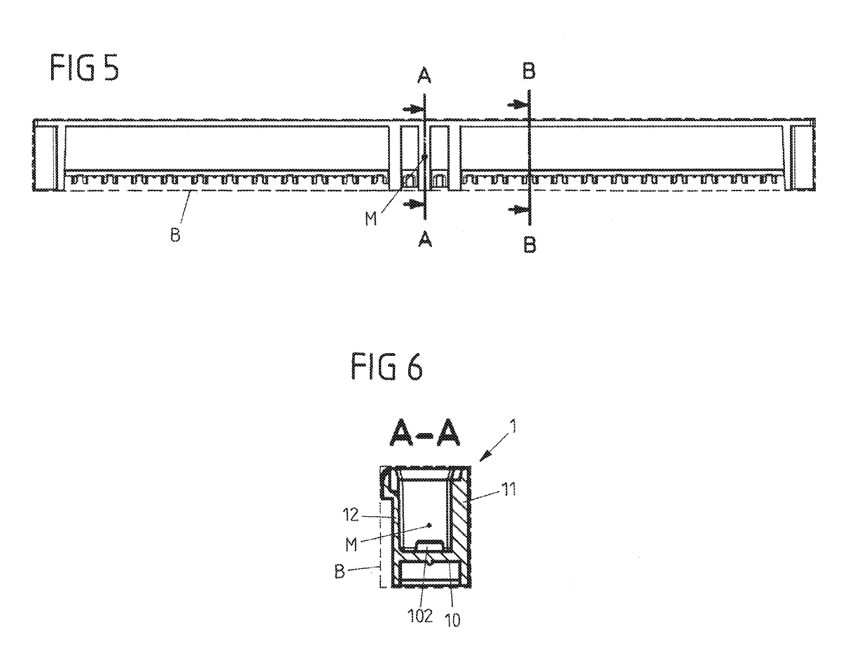

The crosswise webs 104, 105 are configured so as to be symmetrical on the outside 101 of the base 10 with respect to a spanning plane of symmetry running through the center of gravity M (see FIG. 6) of the base strip 1 and through the longitudinal direction L and the insertion direction E.

The shaping with the guide webs 112 that extend lengthwise along the insertion direction E, with the flat side surfaces 110, 120 of the side walls 11, 12 and with the crosswise webs 104, 105 that extend crosswise on the outside of the base 10 yields a base strip having a high degree of stiffness in its entirety.

As can be seen in FIG. 1A, engagement elements 113 also project beyond the crosswise webs 104, 105 in the insertion direction E. The base strip 1 can be placed onto a printed circuit board 3 with a positive fit by means of these engagement elements 113.

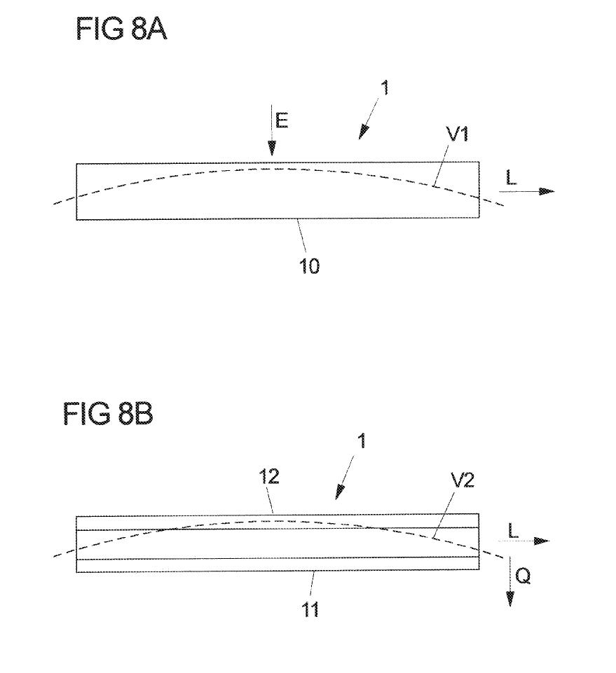

When it comes to a conventional base strip 1 that is made of plastic in a plastic mold at an elevated temperature, the cooling after the production as well as the material shrinkage that occurs in this process give rise to deformations which, as shown schematically in FIGS. 8A and 8B, can lead to a curvature of the base strip 1 in the plane spanned by the insertion direction E and the longitudinal direction L (FIG. 8A, deformation V1) and/or in the plane spanned by the crosswise direction Q and the longitudinal direction L (FIG. 8B, deformation V2). Such a curvature of the base strip 1 is particularly disadvantageous if the base strip 1 is placed onto a printed circuit board 3 and is then to be electrically connected to the printed circuit board 3. If the base 10 of a base strip 1 is to be placed, for example, onto a printed circuit board 3, the deformation V1 shown in FIG. 8A is unfavorable and it prevents the base 10 from being placed flat onto the printed circuit board 3. If, in contrast, in case of lateral installation, a side wall 11, 12 of the base strip 1 is to be placed onto the printed circuit board 3, the deformation V2 shown in FIG. 8B is detrimental.

In contrast, in order to attain an advantageous shrinkage behavior in the case of the base strip 1 according to the present invention, the center of gravity M of the base strip 1 is arranged at the location of the geometric center of gravity of an imaginary geometric cuboid B that envelops the base strip 1. Here, the enveloping cuboid B corresponds to the smallest possible geometric cuboid into which the base strip 1 fits. The enveloping cuboid touches the outer sides of the base strip 1, as can be seen by looking at FIG. 5 and FIG. 6 together.

The enveloping cuboid B has a geometric center of gravity M corresponding to the center of gravity obtained when the cuboid is assumed to be a solid body. The center of gravity M of the base strip 1 is likewise at this center of gravity M. This distribution of material on the base strip 1 in terms of the center of gravity is symmetrical around the center of gravity M and—as has been ascertained empirically—this leads to an advantageous shrinkage behavior during the production of the base strip 1, resulting only in slight deformations of the base strip 1.

Therefore, the base strip 1 is constructed and its sections are designed in such a way that the resulting center of gravity M is precisely one which corresponds to the center of gravity M of the enveloping cuboid B. Such a design can be created by employing appropriate design software tools, for example, CAD tools.

For purposes of influencing the material distribution of the base strip 1, for instance, one of the side walls 11, 12 or both of the side walls 11, 12 can have a (slightly) conical shape. In this manner, starting at the base 10, the thickness of one side wall 11, 12 can increase towards the outside, for example, counter to the insertion direction E, whereby the conicity can be within the range from, for example, 0.5° to 2°, for instance at 1°.

Due to the fact that the base strip 1 exhibits advantageous shrinkage properties, after the production, there is only relatively little deformation of the base strip 1 caused by shrinkage effects. This means that the base strip 1 can advantageously be placed onto a printed circuit board 3, for example, within the scope of an automated assembly, and contact elements 14 that are placed onto the base 10 of the base strip 1 at the receiving openings 103 can be electrically contacted with the printed circuit board 3 in a reliable manner employing suitable soldering methods such as, for instance, so-called reflow soldering.

The base strip 1 can be used with various contact elements 14, as shown in FIGS. 7A and 7B.

For instance, pin-like, straight contact elements 14 can be inserted into the receiving openings 103, as is shown in FIG. 7a. A first section 140 of such contact elements 14 extends into the receiving space 13 of the base strip 1 and projects towards the outside beyond the base 10 in the insertion direction E. By means of such contact elements 14, the base strip 1 can be placed over the base 10 onto an associated printed circuit board 3 so as to be made to engage and to be plugged into associated contact openings on the printed circuit board 3 in order to be connected to the printed circuit board 3 by soldering.

As an alternative, however, it is also possible to use angled contact elements 14 of the type shown in FIG. 7B. A first section 140 of these contact elements 14 projects into the receiving space 13 of the base strip 1, said contact elements 14 extending with an angled section 141 outside of the receiving space 13 along the outside 101 of the base 10 between two associated crosswise webs 104, 105, and projecting towards the outside beyond one of the side walls 11, 12, so that the base strip 1 can be placed onto the printed circuit board 3 with this side wall 11, 12 and can thus be connected horizontally to the printed circuit board 3.

Since the base strip 1 undergoes an advantageous shrinkage behavior, deformations are reduced in the plane (FIG. 8A) spanned by the insertion direction E and the longitudinal direction L as well as in the plane (FIG. 8B) spanned by the crosswise direction Q and the longitudinal direction L. In this manner, the base strip 1 can be placed onto a printed circuit board 3 either with its base 10 or else with one of its side walls 11, 12, without this being hindered by an (excessive) curvature. Consequently, a single type of a base strip 1 can be used for a top installation (via the base 10) or for a side installation (via one of the side walls 11, 12), which can markedly reduce the production and warehousing costs (which would otherwise be incurred for the production and warehousing of different types of base strips).

The notion underlying the invention is not restricted to the embodiments shown here, but rather, it also can be fundamentally implemented in a completely different manner.

A base strip of the type described here is advantageously configured as a multi-pin base strip and therefore it has, for example, more than twelve receiving openings for contact elements. However, it is also fundamentally conceivable to configure a base strip with just a few pins in the manner described here.

A base strip of the type described here can advantageously be made of the plastic LCP. Fundamentally, however, a base strip can also be made of other materials, especially of other plastic materials.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 base strip
10 base
100 bottom
101 outside
102 dome
103 opening
104, 105 crosswise web
11 side wall
110 side surface
111 end edge
112 guide web
113 engagement elements
12 side wall
120 side surface
121 end strip
13 receiving space
14 contact element
140, 141 section
2 plug-in elements
20 line
3 printed circuit board
B enveloping cuboid
E insertion direction
L longitudinal direction
M midpoint
Q crosswise direction
S plug-in site
V1, V2 deformation

1. A base strip for connection to a printed circuit board, comprising:
a first side wall that extends lengthwise along a longitudinal direction;
a second side wall that extends lengthwise along the longitudinal direction and that is at a distance from the first side wall along a crosswise direction that is oriented crosswise to the longitudinal direction, so that, between the side walls, a receiving space is formed into which one or more plug-in elements can be inserted in the insertion direction; and
a base that connects the first side wall and the second side wall to each other and that has a plurality of receiving openings configured to receive electric contact elements,
wherein
the center of gravity of the base strip corresponds to the geometric center of gravity of an imaginary cuboid that envelops the base strip.

2. The base strip according to claim 1, wherein the insertion direction is oriented perpendicularly to the longitudinal direction and perpendicularly to the crosswise direction.

3. The base strip according to claim 1, wherein, on the first side wall, there is a plurality of guide webs which are at a distance from each other along the longitudinal direction, which protrude into the receiving space and which extend along the insertion direction.

4. The base strip according to claim 3, wherein, between two guide webs, as seen in the longitudinal direction, a plug-in site is defined into which a plug-in element can be inserted in the insertion direction.

5. The base strip according to claim 3, wherein an end edge of the first side wall projects beyond the guide webs counter to the insertion direction on a side facing away from the base.

6. The base strip according to claim 1, wherein a side surface of the first side wall extends flat along the longitudinal direction.

7. The base strip according to claim 1, wherein an inside of the base facing the receiving space has a bottom that is configured so as to be flat.

8. The base strip according to claim 7, wherein, projecting from the bottom, there is a plurality of domes which protrude into the receiving space, whereby a receiving opening for a contact element is arranged on each dome.

9. The base strip according to claim 1, wherein an outside of the base facing away from the receiving space has a plurality of crosswise webs that extend along the crosswise direction, whereby a receiving opening is arranged between two crosswise webs.

10. The base strip according to claim 9, wherein, as seen along the crosswise direction, the crosswise webs extend over an entire width of the base.

11. A base strip according to claim 1, wherein the base strip is made of a liquid crystal polymer.

12. The base strip according to claim 1, wherein the base strip has twelve or more receiving openings.
